(19) United States
(12) Patent Application Publication
(10) Pub. No.: US 2012/0134026 A1
(43) Pub. Date: May 31, 2012

(54) Acid and Alkali Resistant Coating for Resin Lens

(76) Inventors: Zhao Zhigang, Zhenjiang (CN); Cai Xiangyou, Zhenjiang (CN)

(21) Appl. No.: 13/308,316

(22) Filed: Nov. 30, 2011

(30) Foreign Application Priority Data
Nov. 30, 2010 (CN) ZL 201020632908.1

(51) Int. Cl. G02B 1/11; B29D 11/00

(52) U.S. Cl. 359/601; 264/1.7

(57) ABSTRACT

An acid and alkali resistant coating for an optical lens comprises: a silicon dioxide layer 1, an antireflection film layer 3, hardening layer 5 applied upon a lens blank 6. Optionally, nickel-chromium alloy layers 2 and 4 are added between the silicon dioxide layer 1 and antireflection film layer 3, between antireflection film layer 3 and hardening layer 5. A layer of nickel-chromium alloy may be added before vacuum coating the antireflection film layer. The layer of nickel-chromium alloy is added so that a hardening layer will be protected and to improve the connection or adhesion of the hardening layer and the antireflection film layer. In addition, a layer of nickel-chromium alloy may also added between the antireflection film layer and waterproof layer. The end product comprises protective antireflection or antiglare film improving acid and alkali resistance.

### RELATED PATENT APPLICATION AND INCORPORATION BY REFERENCE

This is a utility application based upon China patent application Ser. No. ZL 2010 2 0632908.1 filed on flied on Nov. 30, 2010. This related application is incorporated herein by reference and made a part of this application. If any conflict arises between the disclosure of the invention in this utility application and that in the related application, the disclosure in this utility application shall govern. Moreover, the inventor(s) incorporate herein by reference any and all patents, patent applications, and other documents hard copy or electronic, cited or referred to in this application.

### BACKGROUND OF THE INVENTION

### Field of the Invention

The invention generally relates to means and methods of protecting an optical lens. More particularly, various new compositions are disclosed for purposes of improving lens resistance to acid, alkali and other contaminates.

### BRIEF SUMMARY OF THE INVENTION

The present invention overcomes shortfalls in the related art by presenting an unobvious and unique combination, configuration of materials to manufacture a new lens coating useful in protecting lenses from contaminates and environmental factors such as acid rain and alkali exposure.

### BRIEF DESCRIPTION OF THE DRAWINGS

FIG. 1 depicts a sectional view of one embodiment of the invention

### REFERENCE NUMERALS IN THE DRAWINGS

1 a silicon dioxide layer

2 a first nickel-chromium alloy layer

3 an antireflection film layer

4 a second nickel-chromium alloy layer

5 a hardening layer

6 a blank lens

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms.

Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

In general, with the development of eyeglass technology, there are more and more varieties of resin lenses. To improve lens transmission efficiency, coating is usually recommended. However, a typical coating layer is easily destroyed in acid or alkali environment. The hardness of the resin lens is lower, so the resin lens usually needs to undergo a hardening treatment. In addition, for the low transmission efficiency of resin lens, the non-coated lens influences our judgment for the objects seen through the lens, for example, the transmission efficiency of CR39 lens is 92%. Most manufactures try to improve the transmission efficiency from the reflection color of lens instead of improving the lens performance. For instance, with the rising prevalence of acid rain, alkaline solution will be used to wash the lenses. This will require the lens coating to be of increased acid and alkali resistance. Embodiments of the present invention provide such increased acid and alkali resistance.

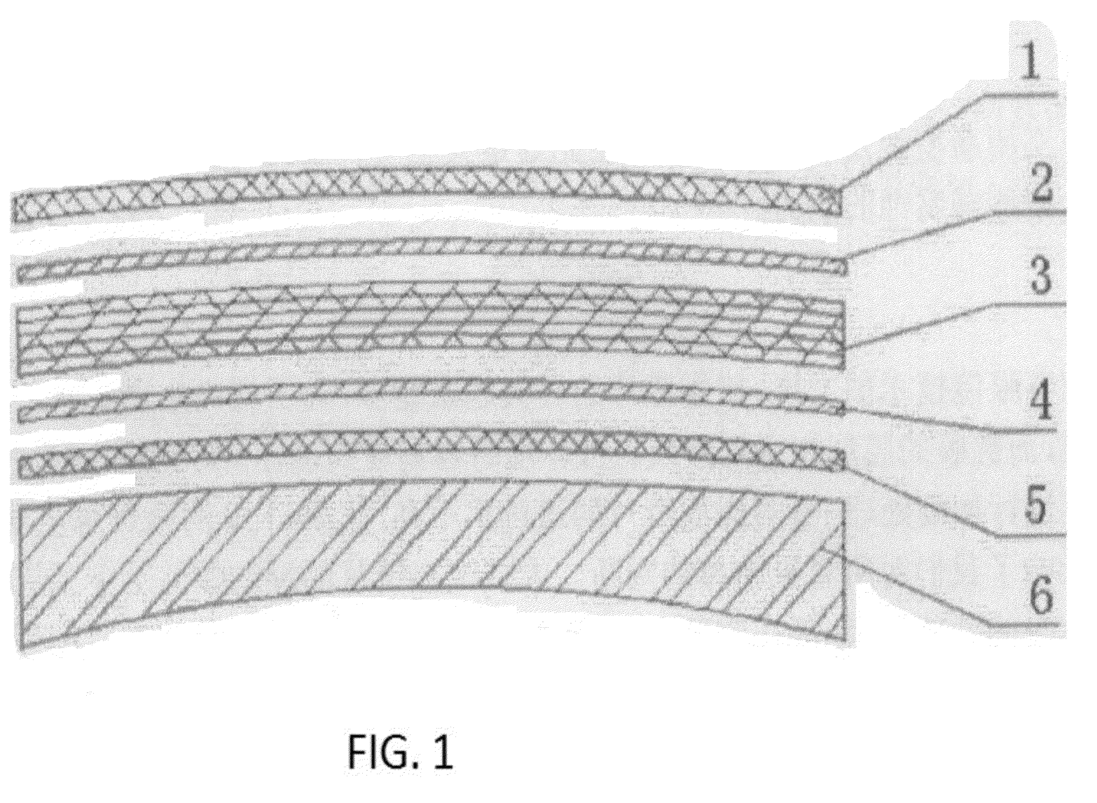

Referring to FIG. 1, an acid and alkali-resistant coating for resin lens comprises a silicon dioxide layer 1, a first nickel-chromium layer 2, antireflection film layer 3, hardening layer 5 and a blank lens 6. The second nickel-chromium alloy layer 4, may be 0.6 to 1.0 nm thick. The second nickel-chromium alloy layer 2 may be 1.5 to 2 nm thick.

A resin lens produced according to this disclosure may be tested for ten minutes in an alkaline solution with the pH value of 12 to 13 with the coating layer undamaged.

Disclosed systems and methods include:

A system for adding acid and alkali resistance to an optic lenses, the optic lens comprising:
a) a silicon dioxide layer;
b) a first nickel-chromium alloy layer;
c) an antireflection film layer;
d) a second nickel-chromium alloy layer; and
e) a hardening layer.

2. The system of claim 1 wherein the second layer of nickel-chromium is between 0.6 to 1.0 nanometers in thickness.

3. The system of claim 1 wherein the first layer of nickel-chromium is between 1.5 to 2.0 nanometers in thickness.

4. A method for improving the resistance of an optic lens to acid and alkali, the method comprising the steps of:

creating an optical lens having layers comprising: a silicon dioxide layer; a first nickel-chromium alloy layer; an antireflection film layer; a second nickel-chromium alloy layer; and a hardening layer.

What is claimed is:

1. A system for adding acid and alkali resistance to an optic lenses, the optic lens comprising:
a) a silicon dioxide layer;
b) a first nickel-chromium alloy layer;
c) an antireflection film layer; and
d) a second nickel-chromium alloy layer.

2. The system of claim 1 wherein the second layer of nickel-chromium is between 0.6 to 1.0 nanometers in thickness.

3. The system of claim 1 wherein the first layer of nickel-chromium is between 1.5 to 2.0 nanometers in thickness.

4. The system of claim 1 adding a hardening layer after the second nickel-chromium alloy layer.

5. The system of claim 1 using a resin optic lens to apply layers a to d.

6. The system of claim 1 wherein the antireflection film layer comprises a polarized film.

7. A method for improving the resistance of an optic lens to acid and alkali, the method comprising the steps of:
a) creating an optical lens having layers comprising: a silicon dioxide layer; a first nickel-chromium alloy layer; an antireflection film layer; a second nickel-chromium alloy layer; and a hardening layer.
